(19) United States
(12) Patent Application Publication
(10) Pub. No.: US 2023/0348715 A1
(43) Pub. Date: Nov. 2, 2023

(54) RESIN COMPOSITION FOR STRAP OF WEARABLE ELECTRONIC DEVICE, AND METHOD FOR MANUFACTURING SAME

(71) Applicants: SAMSUNG ELECTRONICS CO., LTD., Suwon-si (KR); INNOHANA CO., LTD., Hwaseong-si (KR)

(72) Inventors: Jihyoung CHOI, Suwon-si (KR); Duckshin CHOI, Hwaseong-si (KR)

(73) Assignees: SAMSUNG ELECTRONICS CO., LTD., Suwon-si (KR); INNOHANA CO., LTD., Hwaseong-si (KR)

(21) Appl. No.: 18/220,582

(22) Filed: Jul. 11, 2023

Related U.S. Application Data
(63) Continuation of application No. PCT/KR2021/019642, filed on Dec. 22, 2021.

(30) Foreign Application Priority Data
Jan. 11, 2021 (KR) 10-2021-0003468
Apr. 7, 2021 (KR) 10-2021-0045428

(51) Int. Cl. C08L 75/04; C08K 3/30; C08J 3/20; G06F 1/16

(52) U.S. Cl. CPC C08L 75/04; C08K 3/30; C08J 3/20; G06F 1/163; C08K 2003/3045; C08J 2375/04; C08L 2203/20

(57) ABSTRACT

Provided is a resin composition for a strap of a wearable electronic device and a method for manufacturing same. The resin composition for the strap includes: 50% to 80% by weight of a thermoplastic resin having a hardness of 80 Shore A or less, 20% to 50% by weight of a high specific gravity inorganic compound, and may have a specific gravity of 1.6 or more, a hardness of 50 Shore A to 80 Shore A, a tensile strength of 15 MPa to 27 MPa, and a tear strength of 53 kgF/cm 2 to 79 kgF/cm2.

### CROSS-REFERENCE TO RELATED APPLICATIONS

This application is a bypass continuation of PCT International Application No. PCT/KR2021/019642, which was filed on Dec. 22, 2021, and claims priority to Korean Patent Application No. 10-2021-0003468, filed on Jan. 11, 2021, and Korean Patent Application No. 10-2021-0045428, filed on Apr. 7, 2021, in the Korean Intellectual Property Office, the disclosures of which are incorporated herein by reference in their entireties.

### BACKGROUND

### 1. Field

The disclosure relates to a resin composition and a manufacturing method thereof. Specifically, the disclosure relates to a resin composition for a strap of a wearable electronic device and a manufacturing method thereof.

### 2. Description of Related Art

With the continuous release of wearable electronic devices that can be worn on users' bodies, the demand for straps for wearing these wearable electronic devices on bodies is also increasing. In addition, the number of users wearing wearable electronic devices while selecting and replacing straps having various colors, textures, and materials according to their tastes is increasing.

Among the materials of straps for electronic devices, synthetic resin materials have various advantages from the user's point of view, such as being lighter compared to metal, being highly flexible, being easy to color, being less likely to cause allergies, being highly resistant to corrosion, being more durable and capable of expressing various textures compared to leather, and being manufacturable in various shapes. In addition, from the producer's point of view, synthetic resin strap materials are preferred because of their low cost and high productivity.

Although synthetic resin materials may have various specific gravities depending on the composition, to improve user convenience as a strap material, it may be desirable to have a high specific gravity in order to suppress restoration by elasticity during the wearing process. Hence, fluorine-containing elastomers (FKM) having flexibility, elasticity, and high specific gravity may be used in the resin composition for the strap.

### SUMMARY

Provided is a resin composition for the strap of a wearable electronic device, having a low cost and improved wearing comfort.

Further, provided is a method for manufacturing a resin composition for the strap of a wearable electronic device having the characteristics described above.

According to an aspect of the disclosure, a resin composition for a strap of a wearable electronic device may include 50 to 80 percent by weight of a thermoplastic resin having a hardness of 80 Shore A or less, and 20 to 50 percent by weight of a high specific-gravity inorganic compound, and the resin composition may have a specific gravity of 1.6 or more, a hardness of 50 to 80 Shore A, a tensile strength of 15 to 27 MPa, and a tear strength of 53 to 79 kgF/cm².

In an embodiment, the thermoplastic resin may be a plasticizer-free thermoplastic polyurethane resin. In an embodiment, the plasticizer-free thermoplastic polyurethane resin may include a first thermoplastic polyurethane resin having a relatively low hardness, and a second thermoplastic polyurethane resin having a relatively high hardness.

In an embodiment, the hardness of the first thermoplastic polyurethane resin and the hardness of the second thermoplastic polyurethane resin may be 66 Shore A and 71 Shore A, respectively. In an embodiment, the mixing ratio of the first thermoplastic polyurethane resin and the second thermoplastic polyurethane resin may be 1:2 to 2:1 by weight. In an embodiment, the mixing ratio of the first thermoplastic polyurethane resin and the second thermoplastic polyurethane resin may be 2:1 by weight.

In an embodiment, the high specific-gravity inorganic compound may include at least one of zinc oxide or barium sulfate. In an embodiment, the thermoplastic resin may include a mixture of a first thermoplastic polyurethane resin having a hardness of 66 Shore A and a second thermoplastic polyurethane resin having a hardness of 71 Shore A at a weight ratio of 2:1, the high specific-gravity inorganic compound may include barium sulfate, and the mixing ratio of the thermoplastic resin and the high specific-gravity inorganic compound may be 3:2 by weight.

According to an aspect of the disclosure, a method of manufacturing a resin composition for a strap of a wearable electronic device according to another embodiment of the disclosure may include: a first kneading operation of preparing a mixture by kneading 50 to 80 percent by weight of a thermoplastic resin having a hardness of 80 Shore A or less and 20 to 50 percent by weight of a high specific-gravity inorganic compound; an extrusion operation of extrusion-molding the mixture into pellets by extruding the mixture with a first extruder; a second kneading operation of kneading the mixture extrusion-molded into pellets by putting it into a second extruder; and an injection operation of performing molding by injecting the kneaded mixture into a mold from the second extruder.

In an embodiment, the first kneading operation may be performed until the temperature of the mixture being kneaded reaches 180 degrees Celsius. The process temperature of the extrusion operation may be 120 degrees Celsius to 180 degrees Celsius. The process temperature of the second kneading operation may be 180 degrees Celsius to 220 degrees Celsius.

In an embodiment, the second extruder of the second kneading operation may be a twin-screw extruder. The screw rotation speed of the twin-screw extruder may be 180 rpm to 320 rpm.

According to an aspect of the disclosure, a wearable electronic device according to another embodiment of the disclosure is a wearable electronic device including a fastening member configured to be detachably fastened to a user's body, wherein the fastening member may include 50 to 80 percent by weight of a thermoplastic resin having a hardness of less than 80 Shore A, and 20 to 50 percent by weight of a high specific gravity inorganic compound, and may have a specific gravity of 1.6 or more, a hardness of 50 to 80 Shore A, a tensile strength of 15 to 27 MPa, and a tear strength of 53 to 79 kgF/cm². In an embodiment, the thermoplastic resin may be a plasticizer-free thermoplastic polyurethane resin. The high specific-gravity inorganic compound may include at least one of barium sulfate or zinc oxide.

In an embodiment, the plasticizer-free thermoplastic polyurethane resin may include a first thermoplastic polyurethane resin having a hardness of 66 Shore A, and a second thermoplastic polyurethane resin having a hardness of 71 Shore A. The mixing ratio of the first thermoplastic polyurethane resin and the second thermoplastic polyurethane resin may be 1:2 to 2:1 by weight. In an embodiment, the thermoplastic resin may include a mixture of the first thermoplastic polyurethane resin and the second thermoplastic polyurethane resin at a weight ratio of 2:1, the high specific-gravity inorganic compound may include barium sulfate, and the mixing ratio of the plasticizer-free thermoplastic resin and the high specific gravity inorganic compound may be a plasticizer-free thermoplastic polyurethane resin having a mixing ratio of 3:2 by weight.

Various embodiments of the present disclosure provide a resin composition for the strap of a wearable electronic device comprising a low hardness thermoplastic polyurethane and a high specific-gravity inorganic compound, so that the raw material cost is low, the productivity is high, and the wearing comfort can be improved by high specific gravity.

In an embodiment, the resin composition for the strap of a wearable electronic device may have high tensile strength, high tear strength, and high tensile recovery property due to the improved dispersion of inorganic compound particles in the resin matrix.

In an embodiment, a resin composition for the strap of a wearable electronic device having the above-described characteristics can be manufactured by mixing a low hardness thermoplastic polyurethane and a high specific-gravity inorganic compound to prepare pellets and then performing second injection.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment, according to an embodiment;

FIG. 2 is a front perspective view of a mobile electronic device, according to an embodiment;

FIG. 3 is a rear perspective view of the electronic device of FIG. 2, according to an embodiment;

FIG. 4 is an exploded perspective view of the electronic device of FIG. 2, according to an embodiment;

FIG. 5A is a plan view illustrating a fastening member of a wearable electronic device, according to an embodiment;

FIG. 5B is an enlarged view of a portion indicated by ‘E’ in FIG. 5A, according to an embodiment;

FIG. 6 is a flowchart illustrating a manufacturing process of a resin composition for a strap of a wearable electronic device, according to an embodiment;

FIG. 7A is an enlarged photomicrograph of a cross section of a resin composition for a strap of a wearable electronic device, according to Embodiment 1 of the disclosure;

FIG. 7B is an enlarged photomicrograph of a cross section of a resin composition for a strap of a wearable electronic device, according to Embodiment 2 of the disclosure;

FIG. 7C is an enlarged photomicrograph of a cross section of a resin composition for a strap of a wearable electronic device, according to Embodiment 3 of the disclosure;

FIG. 7D is an enlarged photomicrograph of a cross section of a resin composition for a strap of a wearable electronic device, according to Embodiment 4 of the disclosure;

FIG. 7E is an enlarged photomicrograph of a cross section of a resin composition for a strap of a wearable electronic device, according to Embodiment 5 of the disclosure;

FIG. 7F is an enlarged photomicrograph of a cross section of a resin composition for a strap of a wearable electronic device, according to Embodiment 6 of the disclosure; and

FIG. 7G is an enlarged photomicrograph of a cross section of a resin composition for a strap of a wearable electronic device, according to Embodiment 7 of the disclosure.

### DETAILED DESCRIPTION

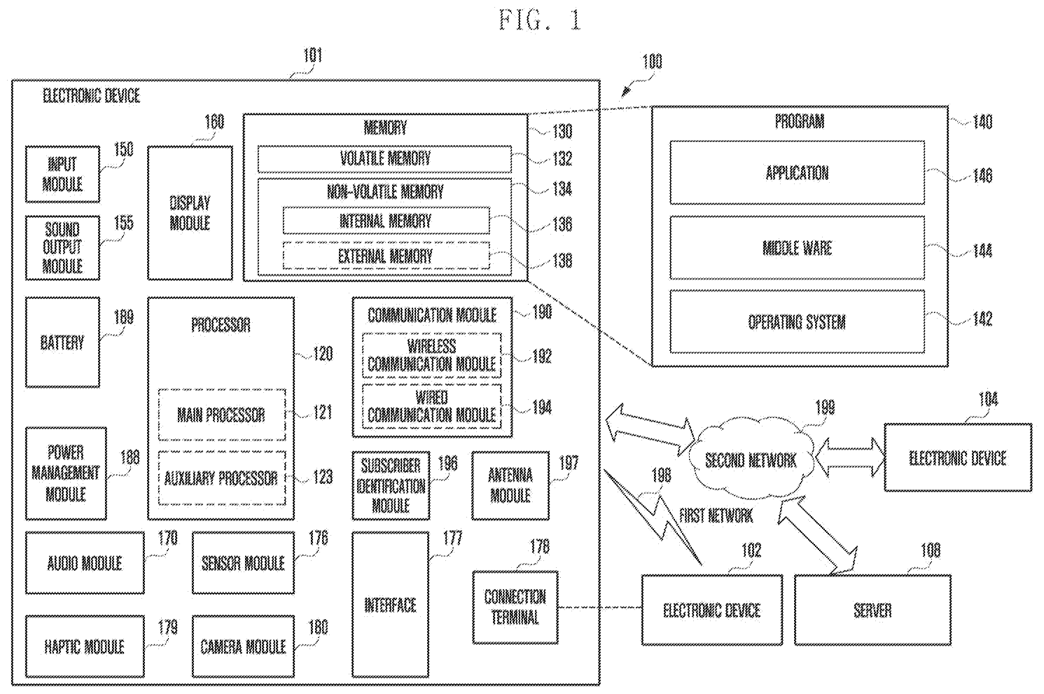

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input 1 module 150, a sound output 1 module 155, a display 1 module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display 1 module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input 1 module 150 may receive a command or data to be used by another component (e.g., the processor 120) of the electronic device 101, from the outside (e.g., a user) of the electronic device 101. The input 1 module 150 may include, for example, a microphone, a mouse, a keyboard, a key (e.g., a button), or a digital pen (e.g., a stylus pen).

The sound output 1 module 155 may output sound signals to the outside of the electronic device 101. The sound output 1 module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display 1 module 160 may visually provide information to the outside (e.g., a user) of the electronic device 101. The display 1 module 160 may include, for example, a display, a hologram device, or a projector and control circuitry to control a corresponding one of the display, hologram device, and projector. According to an embodiment, the display 1 module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input 1 module 150, or output the sound via the sound output 1 module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

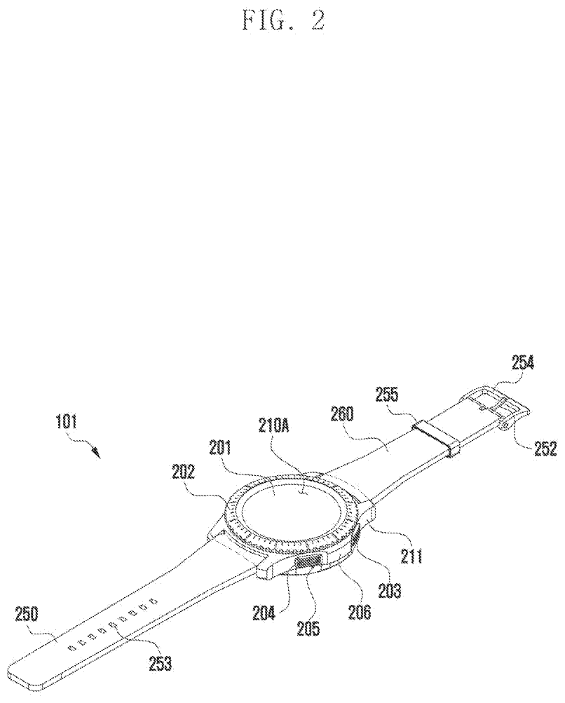

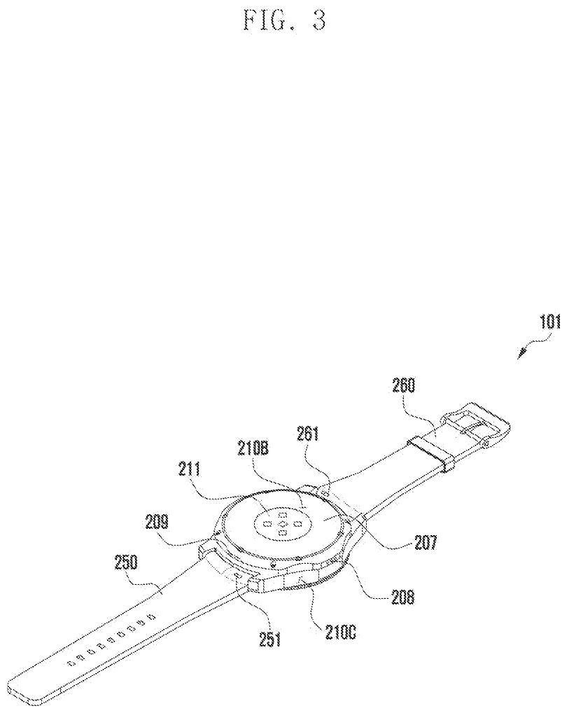

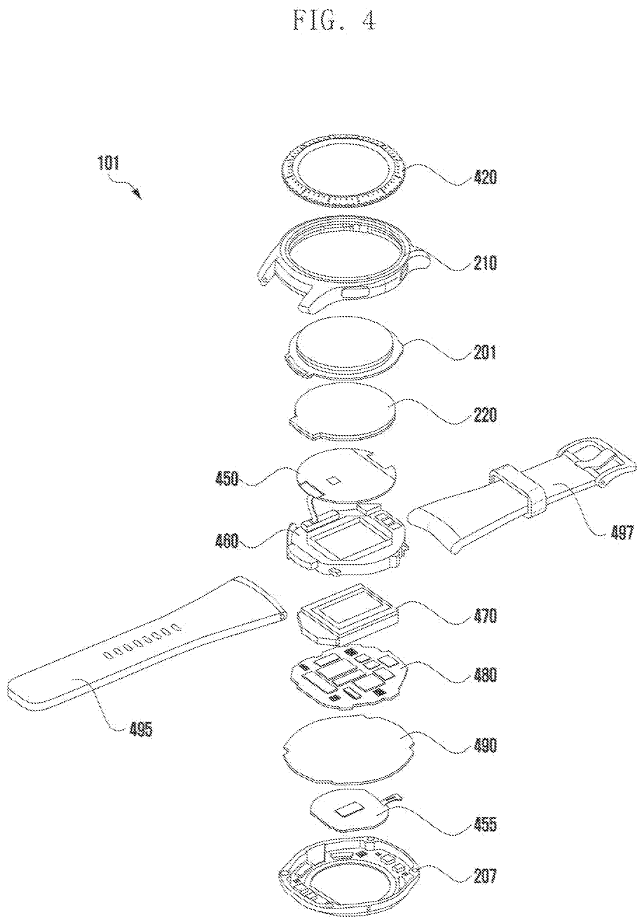

FIG. 2 is a front perspective view of a mobile electronic device, according to an embodiment. FIG. 3 is a rear perspective view of the electronic device of FIG. 2, according to an embodiment. FIG. 4 is an exploded perspective view of the electronic device of FIG. 2, according to an embodiment.

With reference to FIGS. 2 and 3, the electronic device 101 according to an embodiment may include: a housing 210 including a first surface (or, front surface) 210A, a second surface (or, rear surface) 210B, and a side surface 210C surrounding the space between the first surface 210A and the second surface 210B; and a fastening member (250, 260) connected to at least a portion of the housing 210 and configured to detachably fasten the electronic device 101 to a body part (e.g., wrist, ankle) of the user. The fastening member (250, 260) may be, for example, a strap that fixes the electronic device 101 by wrapping it around the user's wrist. In an embodiment, the housing may refer to a structure forming some of the first surface 210A, the second surface 210B, and the side surface 210C in FIG. 1. In an embodiment, the first surface 210A may be formed by a front plate 201 that is substantially transparent at least in part (e.g., glass plate containing various coating layers, or polymer plate). The second surface 210B may be formed by a rear plate 207 that is substantially opaque. The rear plate 207 may be made of, for example, coated or colored glass, ceramic, polymer, metal (e.g., aluminum, stainless steel (STS), or magnesium), or a combination thereof. The side surface 210C may be formed by a lateral bezel structure (or, “lateral member”) 206 that is coupled to the front plate 201 and the rear plate 207 and contains a metal and/or a polymer. In a certain embodiment, the rear plate 207 and the lateral bezel structure 206 may be integrally formed and contain the same material (e.g., metal material such as aluminum). The fastening member (250, 260) may be made of various materials and formed in various shapes. For example, the fastening member (250, 260) may be formed as a single body or as plural unit links that are movable with each other, by woven material, leather, rubber, synthetic resin, metal, ceramic, or a combination thereof.

In an embodiment, the electronic device 101 may include at least one of a display 220 (refer to FIG. 3), audio modules 205 and 208, a sensor module 211, key input devices 202, 203 and 204, or a connector hole 209. In a certain embodiment, the electronic device 101 may be configured to omit at least one of the components (e.g., key input devices 202, 203 and 204, connector hole 209, or sensor module 211) or additionally include other components.

The display 220 may be visually exposed through, for example, a significant portion of the front plate 201. The display 220 may have a shape corresponding to the shape of the front plate 201 and may be in a shape such as a circle, an ellipse, and a polygon. The display 220 may be disposed in combination with or adjacent to a touch sensing circuit, a pressure sensor capable of measuring the intensity (pressure) of a touch, and/or a fingerprint sensor.

The audio modules 205 and 208 may include a microphone hole 205 and a speaker hole 208. In the microphone hole 205, a microphone for picking up external sounds may be disposed therein, and plural microphones may be arranged to sense the direction of a sound in a certain embodiment. The speaker hole 208 may be used for an external speaker and a call receiver. In a certain embodiment, the speaker hole 208 or 214 and the microphone hole 203 may be implemented as a single hole, or a speaker may be included without the speaker hole 208 or 214 (e.g., piezo speaker).

The sensor module 211 may generate an electrical signal or data value corresponding to an internal operating state of the electronic device 101 or an external environmental state. The sensor module 211 may include, for example, a biometric sensor module 211 (e.g., HRM sensor) disposed on the second surface 210B of the housing 210. The electronic device 101 may further include a sensor module including at least one of, for example, a gesture sensor, a gyro sensor, an air pressure sensor, a magnetic sensor, an acceleration sensor, a grip sensor, a color sensor, an infrared (IR) sensor, a biometric sensor, a temperature sensor, a humidity sensor, or an illuminance sensor.

The key input devices 202, 203 and 204 may include a wheel key 202 disposed on the first surface 210A of the housing 210 and rotatable in at least one direction, and/or side key buttons 203 and 204 disposed on the side surface 210C of the housing 210. The wheel key may have a shape corresponding to the shape of the front plate 201. In an embodiment, the electronic device 101 may be configured not to include some or all of the key input devices 202, 203 and 204 described above, and the key input device 202, 203 or 204 that is not included may be implemented in a form of a soft key or touch key on the display 220. The connector hole 209 may accommodate a connector (e.g., USB connector) for transmitting and receiving power and/or data to and from an external electronic device, and may include another connector hole that can accommodate a connector for transmitting and receiving an audio signal to and from an external electronic device. The electronic device 101 may further include, for example, a connector cover that covers at least a portion of the connector hole 209 and blocks foreign substances from entering the connector hole.

The fastening member (250, 260) may be detachably fastened to at least a portion of the housing 210 by using locking members 251 and 261. The fastening member (250, 260) may include one or more of a fixing member 252, fixing member fastening holes 253, a band guide member 254, and a band fixing ring 255.

The fixing member 252 may be formed to fix the housing 210 and the fastening member (250, 260) to a body part (e.g., wrist, ankle) of the user. The fixing member fastening holes 253 may fix the housing 210 and the fastening member (250, 260) to a body part of the user in correspondence to the fixing member 252. The band guide member 254 may be formed to limit the range of movement of the fixing member 252 when the fixing member 252 engages with a fixing member fastening hole 253, so that the fastening member (250, 260) may be fastened in close contact to a body part of the user. The band fixing ring 255 may limit the range of movement of the fastening member (250, 260) while the fixing member 252 and the fixing member fastening hole 253 are fastened.

With reference to FIG. 4, the electronic device 101 may include a lateral bezel structure 410, a wheel key 420, a front plate 201, a display 220, a first antenna 450, a second antenna 455, a support member 460 (e.g., bracket), a battery 470, a printed circuit board 480, a sealing member 490, a rear plate 493, and a fastening member (495, 497). The support member 460 may be disposed inside the electronic device 101 and connected to the lateral bezel structure 410, or may be integrally formed with the lateral bezel structure 410. The support member 460 may be made of, for example, a metal material and/or a non-metal (e.g., polymer) material. The display 220 may be coupled to one surface of the support member 460 and the printed circuit board 480 may be coupled to the other surface. A processor, a memory, and/or an interface may be mounted on the printed circuit board 480. The processor may include, for example, at least one of a central processing unit, an application processor, a graphics processing unit, an application processor, a sensor processor, or a communication processor.

The memory may include, for example, a volatile memory or a non-volatile memory. The interface may include, for example, a high definition multimedia interface (HDMI), a universal serial bus (USB) interface, an SD card interface, and/or an audio interface. The interface may electrically or physically connect, for example, the electronic device 101 to an external electronic device, and may include a USB connector, an SD card/MMC connector, or an audio connector.

The battery 470 may supply power to at least one component of the electronic device 101, and may include, for example, a primary cell which is not rechargeable, a secondary cell which is rechargeable, or a fuel cell. At least a portion of the battery 470 may be disposed substantially coplanar with, for example, the printed circuit board 480. The battery 470 may be integrally disposed inside the electronic device 101, or may be disposed detachably from the electronic device 101.

The first antenna 450 may be disposed between the display 220 and the support member 460. The first antenna 450 may include, for example, a near field communication (NFC) antenna, a wireless charging antenna, and/or a magnetic secure transmission (MST) antenna. The first antenna 450 may perform short-range communication with, for example, an external device or wirelessly transmit or receive power required for charging, and may transmit a short-range communication signal or a magnetic-based signal containing payment data. In an embodiment, an antenna structure may be formed by a part of the lateral bezel structure 410 and/or the support member 460 or a combination thereof.

The second antenna 455 may be disposed between the printed circuit board 480 and the rear plate 493. The second antenna 455 may include, for example, a near field communication (NFC) antenna, a wireless charging antenna, and/or a magnetic secure transmission (MST) antenna. The second antenna 455 may perform short-range communication with, for example, an external device or wirelessly transmit or receive power required for charging, and may transmit a short-range communication signal or a magnetic-based signal containing payment data. In an embodiment, an antenna structure may be formed by a part of the lateral bezel structure 410 and/or the rear plate 493 or a combination thereof.

The sealing member 490 may be positioned between the lateral bezel structure 410 and the rear plate 493. The sealing member 490 may be formed to block moisture and foreign substances from flowing into a space surrounded by the lateral bezel structure 410 and the rear plate 493 from the outside.

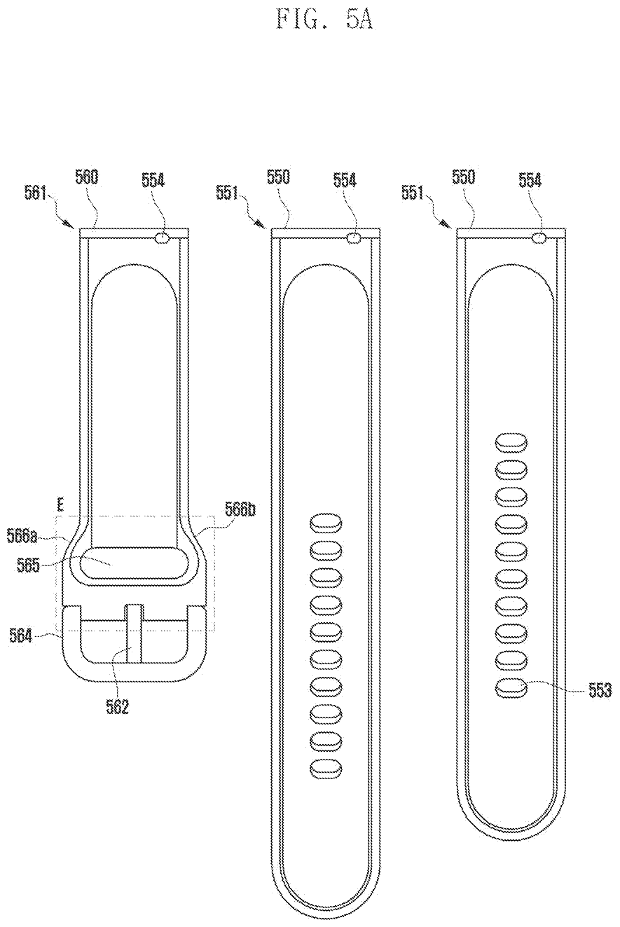

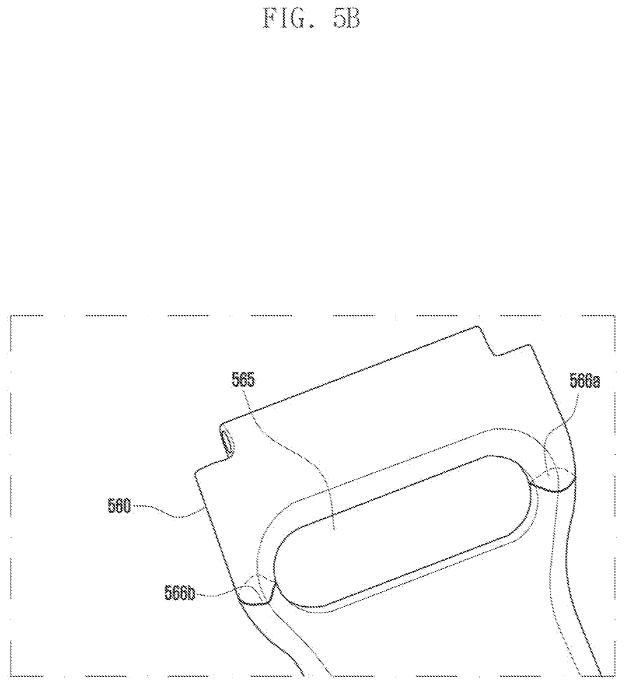

FIG. 5A is a plan view illustrating a fastening member (550, 560) of a wearable electronic device, according to an embodiment.

FIG. 5B is an enlarged view of a portion indicated by ‘E’ in FIG. 5A, according to an embodiment.

With reference to FIG. 5A, the fastening member (550, 560) may include a second fastening member 560 and a first fastening member 550.

The first fastening member 550 may include a spring bar through hole 551 formed at one end through which a spring bar passes, and a plurality of fixing member fastening holes 553 for being fixed to a band guide member 564. The second fastening member 560 may include a spring bar through hole 561 formed at one end through which a spring bar passes, a band guide member 564 for passing and guiding the first fastening member 550, and a fixing member 562 passing through a fixing member fastening hole 553 of the first fastening member 550 to fix the first fastening member 550.

In an embodiment, the fastening member (550, 560) may have a quick release structure. Quick release refers to a structure in which the locking members (251 and 261 in FIG. 3) are exposed in order to quickly release the coupling between the locking members 251 and 261 and the housing 510. Quick release holes 554 through which the locking members 251 and 261 are exposed may be formed on the side surfaces of the spring bar through holes 541 of the second fastening member 560 and the first fastening member 550. As shown in FIG. 5A, the first fastening member 550 may have various lengths, and the user can quickly release the coupling of the locking members 251 and 261 through the quick release holes 554 and can easily replace various fastening members (550, 560) according to the user's wrist thickness or preference.

In an embodiment, the second fastening member 560 may have a loop-free shape. The loop-free shape may include, in replacement of the band fixing ring 255 in FIG. 2, a loop hole 565 formed to pass an end portion of the first fastening member 550 in a region adjacent to the band guide member 564 of the second fastening member 560. When the user wears the strap, the end portion of the first fastening member 550 fastened to the band guide member 564 may pass through the loop hole 565 and be fixed between the user's wrist surface and the inner surface of the second fastening member 560. Compared to the band fixing ring 255 in FIG. 2, the loop-free shape has a low possibility of damage because the band fixing ring 255 does not protrude; as the end portion of the first fastening member 550 does not protrude to the outside, there is little interference with the clothes worn by the user, such as a shirt sleeve, and thus the wearing comfort is excellent. With reference to FIG. 5B, the cross-sectional area of the second fastening member 560 may be narrowed at both ends 566a and 566b of the loop hole 565, which will be described later.

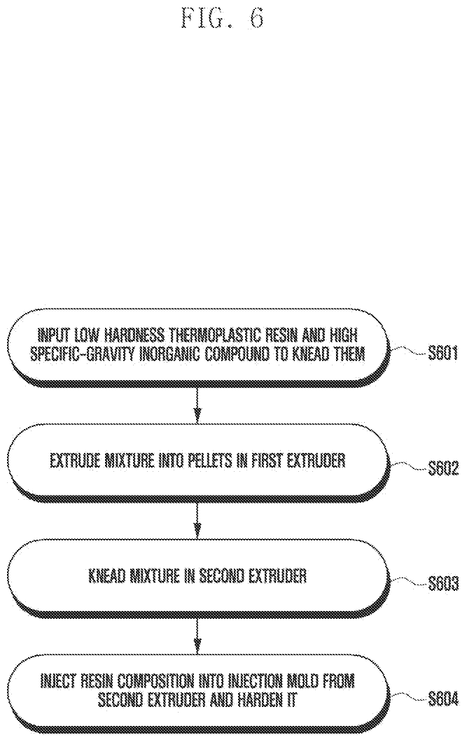

FIG. 6 is a flowchart illustrating a manufacturing process of a resin composition for the strap of a wearable electronic device, according to an embodiment.

With reference to FIG. 6, the manufacturing process of a resin composition for the strap of a wearable electronic device according to embodiments of the disclosure may include a first kneading operation S601, an extrusion operation S602, a second kneading operation S603, and an injection operation S604.

The first kneading operation S601 may be a operation of preparing a mixture by introducing and mixing 50 to 80 percent by weight of a low hardness thermoplastic resin and 20 to 50 percent by weight of a high specific-gravity inorganic compound in a kneading machine.

In an embodiment, the kneading machine used in the first kneading operation S601 may be a kneader. The kneader is an equipment used for kneading and mixing high-viscosity materials in a paste state, and may include, for example, a kneader body and a plurality of blades that rotate in engagement with each other inside the kneader body to knead raw materials. The shape of the blade may be a sigma type, a Z type, a fish-nail type, a cutter type, or a known kneader blade shape similar thereto.

In the first kneading operation S601, the temperature may be increased by frictional force and an external heat source. In an embodiment, the first kneading operation S601 may be performed until the temperature of the mixture reaches 180 degrees Celsius inside the kneading machine. When the temperature of the mixture exceeds 180 degrees Celsius in the first kneading operation S601, deterioration in physical properties due to thermal decomposition of the thermoplastic resin may occur in the extrusion process described later, and thus it is desirable not to exceed 180 degrees Celsius.

In an embodiment, the low hardness thermoplastic resin introduced in the first kneading operation S601 may be low hardness thermoplastic polyurethane resin (TPU). The thermoplastic polyurethane resin is segmented polymers with soft and hard segments. Due to these characteristics, the thermoplastic polyurethane resin may have excellent elasticity. Hard segments of the thermoplastic polyurethane resin are derived from hydroxyl-terminated polyethers or polyesters, and hard segments are derived from isocyanates and chain extenders. The chain extender may generally be one of a variety of glycols, and may be 1,3-propanediol or 1,4-butanediol for example.

In an embodiment, to be manufactured with low hardness (meaning a hardness of 80 or less on the Shore A scale) due to problems such as reactivity and injection moldability, the low-hardness thermoplastic polyurethane resin may include a plasticizer such as a phthalate-based plasticizer. In general, when a thermoplastic polyurethane resin has a hardness above 80 Shore A, it has physical properties like hard plastic, so it may be unsuitable for use as a resin composition for the strap of a wearable electronic device requiring elasticity like rubber.

In an embodiment, the low hardness thermoplastic polyurethane resin may be a plasticizer-free thermoplastic polyurethane resin. The plasticizer-free thermoplastic polyurethane resin may also be referred to as a non-plasticizer thermoplastic polyurethane resin. The non-plasticizer thermoplastic polyurethane resin may be obtained, for example, by reacting a hydroxyl-terminated polyether and polyester intermediate and a glycol chain extender including at least one of aromatic diisocyanate, ethylene glycol, or propylene glycol, and hydroxyl terminated polyether intermediates may be composed of repeating units derived from branched glycols reacted with alkylene oxides. The above-described composition of non-plasticizer thermoplastic polyurethane is illustrative, and for the disclosure, a known technique for securing plasticity of thermoplastic polyurethane by not adding a plasticizer or adding only a small amount of a plasticizer may be referred to.

Blooming can be frequently observed in thermoplastic polyurethanes containing plasticizers, and is a phenomenon in which additives or internal raw materials in synthetic resin migrate to the skin layer to whiten the surface or expose foreign substances to the surface. This not only impairs the appearance of the product but also reduces adhesiveness, which may cause poor adhesion or poor painting. A non-plasticizer low-hardness polyurethane resin achieves low hardness without containing a plasticizer inside, it has the advantage of being able to solve the blooming caused by surface migration of the plasticizer.

In an embodiment, the low hardness thermoplastic polyurethane resin may include a first thermoplastic polyurethane resin and a second thermoplastic polyurethane resin having different hardness. When the hardness of a thermoplastic polyurethane resin is low, flexibility and elasticity may be excellent and a soft wearing comfort may be exhibited, but mechanical properties (e.g., tensile strength and tear strength) may be relatively poor. In addition, when the hardness of a thermoplastic polyurethane resin is high, mechanical properties may be excellent, but relatively hard wearing comfort may be exhibited. In the case of preparing a resin composition by kneading first and second thermoplastic polyurethane resins having different hardness, a resin composition having excellent flexibility and elasticity while having high mechanical properties can be obtained. The hardness of the first thermoplastic polyurethane resin may preferably be 66 Shore A, and the hardness of the second thermoplastic polyurethane resin may be preferably 71 Shore A.

The high specific-gravity inorganic compound is required to have a high specific gravity so as to increase the specific gravity of the resin composition, have no or low reactivity with a low-hardness thermosetting resin being the matrix material, be insoluble in water or other solvents, and be able to be uniformly mixed with a low-hardness thermosetting resin being the matrix material. The specific gravity of the high specific-gravity inorganic compound is preferably 3.5 to 5.6. When the specific gravity is 3.5 or less, physical properties of the resin composition deteriorate because an excess amount must be added to adjust the specific gravity; when the specific gravity exceeds 5.6, the difference in specific gravity from the low-hardness thermosetting resin is too large and the mixing uniformity is lowered, so physical properties may also be deteriorated. In an embodiment, the high specific-gravity inorganic compound may include at least one of zinc oxide (ZnO) or barium sulfate (BaSO₄), preferably barium sulfate. Barium sulfate having a specific gravity of 4.5 may achieve the specific gravity required for the resin composition by mixing in an appropriate amount, and can be uniformly mixed with the low-hardness thermosetting resin.

In the extrusion operation S602, the mixture mixed in the first kneading operation S601 is extruded through an extruder. An extruder is an equipment that pressurizes raw materials in the form of rubber, paste or slurry to form them to have a specific cross-sectional shape, and may include a barrel part through which the raw material passes inside, a screw that pressurizes the raw material while rotating in the barrel part, and a die that extrudes the raw material pressurized from the end portion of the screw to have a specific cross-sectional shape. The mixture extruded in the extrusion operation S602 may be cut to have a pellet form.

In an embodiment, the temperature of the mixture inside the extruder in the extrusion operation S602 may be 120 degrees Celsius to 180 degrees Celsius. When the temperature is less than 120 degrees, the low hardness thermosetting resin does not have sufficient plasticity; when the temperature exceeds 180 degrees, thermal decomposition of the low hardness thermoplastic resin may occur in the injection operation S604 to be described later, resulting in deterioration in physical properties.

The extrusion operation S602 corresponds to a pretreatment process that treats the resin composition according to the disclosure to have a degree of mixing and reactivity suitable for the subsequent process prior to performing the second kneading operation S603 and the injection operation S604 described later. In the case of performing the pretreatment process, uniformity of mixing of the low hardness thermoplastic resin and the high specific-gravity inorganic compound, which are in a mixed phase of different materials, can be improved. In a resin composition including a mixed phase, an interphase interface between different materials may act as a weakness of the material. When an external stress is applied to the resin composition, the interphase interface may act as a starting point of fracture or accelerate the progress of fracture as the stress is concentrated. Therefore, when the uniformity of the low hardness thermoplastic resin and the high specific-gravity inorganic compound is increased, the mechanical properties of the resin composition of the disclosure can be improved. In addition, when the low hardness thermoplastic resin is a mixture of first and second thermoplastic polyurethane resins having different hardness, as the degree of mixing of the first and second thermoplastic polyurethane resins is improved through the pretreatment process, mechanical properties of the resin itself may also be improved.

The second kneading operation S603 may be a operation of introducing the mixture prepared in the form of pellets in the extrusion operation S602 into an extruder and kneading it in the extruder. In an embodiment, the extruder of the second kneading operation S603 may be basically the same as the extruder used in the extruding operation S602, but In an embodiment, the extruder of the second kneading operation S603 may be preferably a twin-screw extruder in which raw materials are kneaded and simultaneously pressurized through two screws rotating in engagement with each other inside the extruder body. Since the twin-screw extruder has an advantage of excellent kneading function compared to a single-screw extruder having one screw, it can increase the uniformity of mixing between the low hardness thermoplastic resin and the high specific-gravity inorganic compound of the disclosure, thereby improving the mechanical properties of the resin composition.

In an embodiment, the screw speed of the twin screw extruder may be 180 rpm to 320 rpm. When the screw speed is 180 rpm or less, it has been confirmed that uniformity is lowered and the color of the final product is poor. In addition, when the screw speed is 320 rpm or more, it has been confirmed that physical properties deteriorate due to causes such as deterioration of the resin material due to screw friction.

In some examples, the temperature of the mixture in the twin screw extruder may be between 180 and 220 degrees Celsius. When the temperature is less than 180 degrees in the twin screw extruder, the kneading of the low hardness thermoplastic resin may be not sufficient; when the temperature exceeds 220 degrees, excessive thermal decomposition of the low hardness thermoplastic resin may occur, resulting in deterioration of physical properties.

The injection operation S604 may be an operation for performing injection molding in which the mixture is injected from the outlet of the extruder in the second kneading operation S603 into an injection mold having a shape of the strap of a wearable electronic device, which is the final product, the injected mixture hardens, and then the mold is separated to obtain the final product. Compared to other synthetic resin molding methods such as hot press molding, injection molding has advantages of high productivity due to short process cycle time, and low equipment cost. However, injection molding has disadvantages of being applicable only to thermoplastic resins, and not being applicable to thermosetting resins that harden by a chemical reaction as heat is applied.

Compared to FKM, which is a resin composition for the strap of a comparative example, FKM is a thermosetting resin and is produced by a hot press molding method, in which raw materials are put between hot pressing dies, the raw materials are hardened for 450 seconds in the pressurized and heated state of the die, and the hardened product is separated from the die. Comparing this with injection molding of the resin composition according to an embodiment of the disclosure, the resin composition according to the disclosure is injected into an injection mold, it is hardened in 60 seconds, and the final product can be separated from the mold. Hence, as to the resin composition for the strap of a wearable electronic device according to the disclosure, it is produced by injection molding, resulting in excellent productivity; and a large amount of products can be produced with only a small number of mold facilities, thereby reducing cost.

In the following test examples, the resin composition according to various embodiments of the disclosure was fabricated. The composition and manufacturing method of each embodiment are shown in Table 1.

TABLE 1

| | Em- | Em- | Em- | Em- | Em- | Em- | Em- |
|---|---|---|---|---|---|---|---|
| Clas- | bodi- | bodi- | bodi- | bodi- | bodi- | bodi- | bodi- |
| sifi- | ment | ment | ment | ment | ment | ment | ment |
| cation | 1 | 2 | 3 | 4 | 5 | 6 | 7 |
| T460A | 49.55% | — | 60.6% | 65.55% | 49.55% | 19.7% | 39.7% |
| T465A | — | 64.55% | — | — | — | 39.7% | 19.7% |
| BaSO₄ | 49.55% | — | 11.5% | 43.55% | 49.55% | 39.7% | 39.7% |
| ZnO | — | 34.55% | 27% | — | — | — | — |
| Wax | 0.6% | 0.6% | 0.6% | 0.6% | 0.6% | 0.6% | 0.6% |
| AO1010 | 0.3% | 0.3% | 0.3% | 0.3% | 0.3% | 0.3% | 0.3% |
| Pre- | With- | With- | With- | With- | With | With | With |
| treat- | out | out | out | out | pre- | pre- | pre- |
| ment | pre- | pre- | pre- | pre- | treat- | treat- | treat- |
| | treat- | treat- | treat- | treat- | ment | ment | ment |
| | ment | ment | ment | ment | | | |

All percentages in Table 1 refer to weight percentages. In Table 1, T460A indicates a plasticizer-free thermoplastic polyurethane resin material having a hardness of 66 Shore A, and T465A indicates a plasticizer-free thermoplastic polyurethane resin material with a hardness of 71 Shore A of the same company.

In Table 1, Wax and A01010 as antioxidants were added at 0.6 percent and 0.3 percent by weight, respectively, in all embodiments. However, this is illustrative and not intended to limit the disclosure, and it should be understood that known synthetic resin additives may be added to the resin composition of the disclosure for the purpose of preventing oxidation.

With reference to Table 1, it can be seen that in this test example, examples in which the thermoplastic polyurethane resin was mixed at 49.55 to 65.55 percent by weight were prepared, and when the thermoplastic polyurethane resin is a mixture of a first thermoplastic polyurethane resin and a second thermoplastic polyurethane resin, the mixing ratio is 1:2 to 2:1 by weight. However, the mixing ratio in Table 1 does not limit the disclosure, and even a range predictable by a person skilled in the art from the embodiments in Table 1 may be included in the disclosure.

In addition, with reference to Table 1, Embodiments 1 to 4 are resin compositions obtained by directly introducing raw materials into a twin-screw extruder and performing kneading and injection without undergoing pretreatment (meaning the first kneading operation S601 and extrusion operation S602 in the manufacturing method of the disclosure). Further, Embodiments 5 to 7 are resin compositions fabricated by a method of kneading and injecting a pellet-like mixture prepared through pretreatment by using a twin-screw extruder. The difference in physical properties according to the difference in manufacturing method will be explained through test results to be described later.

In the following test examples, the resin compositions of individual embodiments in Table 1 were fabricated to measure physical properties, and the results are shown in Table 2.

TABLE 2

| | Com- | Em- | Em- | Em- | Em- | Em- | Em- | Em- |
|---|---|---|---|---|---|---|---|---|
| | parative | bodi- | bodi- | bodi- | bodi- | bodi- | bodi- | bodi- |
| Classifi- | embodi- | ment | ment | ment | ment | ment | ment | ment |
| cation | ment | 1 | 2 | 3 | 4 | 5 | 6 | 7 |
| Hardness | 72~74 | 71 | 65 | 68 | 66 | 76 | 76 | 76 |
| (Shore A) | | | | | | | | |
| Specific | 2.0~2.1 | 1.78 | 1.80 | 1.80 | 1.76 | 1.75 | 1.60 | 1.77 |
| gravity | | | | | | | | |
| Tensile | 13.4~14.1 | 15.38 | 17.98 | 17.43 | 16.21 | 26.66 | 25.54 | 23 |
| strength | | | | | | | | |
| (MPa) | | | | | | | | |
| Tear | 20~28 | 54.73 | 58.44 | 58.85 | 53.22 | 76.94 | 78.39 | 79.06 |
| strength | | | | | | | | |
| (kgf/cm²) | | | | | | | | |

In Table 2, the resin composition according to the comparative example is a fluorine-containing elastomer (FKM) used as a resin composition for the strap. The hardness values in Table 2 are measured values by Shore hardness according to ASTM D2240. Shore hardness is a measurement method used to measure the hardness of materials such as synthetic resins, and a Shore durometer may press a presser foot having a specific shape with respect to a specimen with a specific force and measure the penetration depth of the indenter from the surface of the specimen. In the A scale of the Shore hardness scale, a truncated conical presser foot having a base diameter of 1.4 mm, an end diameter of 0.79 mm, and a cone angle of 35 degrees is pressed with a force of 8.05 newtons to measure the penetration depth of the presser foot. In this test example, the specimen of each embodiment was pressed at three different positions, and hardness values were measured and averaged. Specific gravity values in Table 2 were measured based on test method A of ASTM D792. Specific gravity is a dimensionless number as a relative value of density based on the density of distilled water at 23 degrees Celsius. The specific gravity measurement method was performed through the operations of measuring the weight of the specimen, measuring the weight in air by hanging the specimen on a thin wire, and measuring the weight while completely immersing the specimen in distilled water at 23 degrees Celsius. Specific gravity can be calculated by substituting the measurement results into the following equation.

g=a/(a+w−b) [Equation 1]

In Equation 1, a is the weight measured in air, b is the weight of the specimen and thin wire measured in air, w is the weight of the specimen immersed in distilled water, and g is the specific gravity of the specimen.

Tensile strength values in Table 2 were measured by applying the ASTM D412 standard. Specimens were manufactured by molding the samples of individual embodiments into ASTM D412 Type C specimens; a tensile force was applied at a speed of 500 mm/min by using a universal testing machine (UTM) equipment; and the value obtained by dividing the tensile force at break by the cross-sectional area of the specimen was used as tensile strength. In the tensile test, the elastic modulus at 20% and 100% elongation and the elongation at break can be measured simultaneously.

The tear strength values in Table 2 were measured by applying the ASTM D624 standard. The specimens were ASTM D624 Type C specimens; the splitting speed of the jaw of the UTM facility was 500 mm/min, the maximum force when the notched part of the specimen was completely torn was recorded, measurements were performed 5 times, and the average value was taken.

With reference to Table 2, it can be seen that the specific gravity value of the resin composition according to the embodiments of the disclosure exhibits a value of 1.6 to 1.8. It can be seen that this numerical range is improved in comparison to a value of 1.1, which is a general specific gravity value of thermoplastic polyurethane, and is close to a value of 2.0, which is the specific gravity of the FKM material of the comparative example. Such a high specific gravity can improve wearing comfort felt by a user when wearing a wearable electronic device, compared to a resin composition using thermoplastic polyurethane alone.

In addition, with reference to Table 2, it can be seen that the mechanical properties such as tensile strength and tear strength of the resin composition according to the embodiments of the disclosure are excellent compared to FKM of the comparative example. Further, it can be seen that the mechanical properties of Embodiments 5 to 7 are excellent in comparison to Embodiments 1 to 4. As described above, this may be because the uniformity of the high specific-gravity compound in the resin composition is high by performing the pretreatment.

In the following test examples, the resin composition according to embodiments of the disclosure was manufactured into the shape of a strap shown in FIG. 5, and the durability of the strap was tested. The test results are shown in Table 3.

TABLE 3

| | Com- | Em- | Em- | Em- | Em- | Em- | Em- | Em- |
|---|---|---|---|---|---|---|---|---|
| | parative | bodi- | bodi- | bodi- | bodi- | bodi- | bodi- | bodi- |
| | embodi- | ment | ment | ment | ment | ment | ment | ment |
| Classification | ment | 1 | 2 | 3 | 4 | 5 | 6 | 7 |
| Water | no | no | no | no | no | no | no | no |
| immersion | blooming | blooming | blooming | blooming | blooming | blooming | blooming | blooming |
| High | no | no | no | no | no | no | no | no |
| humidity | blooming | blooming | blooming | blooming | blooming | blooming | blooming | blooming |
| environment | | | | | | | | |
| Artificial | no | no | no | no | no | no | no | no |
| sweat | abnormal | abnormal | abnormal | abnormal | abnormal | abnormal | abnormal | abnormal |
| | appearance | appearance | appearance | appearance | appearance | appearance | appearance | appearance |
| Tensile | <4 | <6 | <6 | <6 | <3 | <2 | <4 | <1 |
| deformation | | | | | | | | |
| (mm) | | | | | | | | |

In the water immersion test of Table 3, each sample was immersed in water at 80 degrees Celsius for 24 hours, and then it was visually checked whether a blooming phenomenon appeared on the surface of the polyurethane resin; in the high-humidity environment test, each sample was exposed to an atmospheric environment of 50 degrees Celsius and 95% humidity for 72 hours, and then it was visually checked whether a blooming phenomenon appeared on the surface of the polyurethane resin. In the artificial sweat exposure test of Table 3, each sample was immersed in an artificial sweat solution in which 0.96 ml of lactic acid, 1 g of urea, and 5 g of sodium chloride were dissolved in 1 L of water and was left in an atmospheric environment at a temperature of 50 degrees Celsius for 24 hours, and then it was checked whether the exterior was damaged. For the tensile deformation in Table 3, as an index for evaluating the tensile recovery properties of the resin composition, the sample of each embodiment was manufactured in the shape of the second fastening member 560 shown in FIG. 5A, a tensile force of 5 kgf was applied in the length direction for 10 seconds, and the difference between the lengths before and after the application of the tensile force was measured. With reference to FIGS. 5A and 5B, the second fastening member 560 has a shape including a loop hole 565, and the width of the second fastening member 560 narrows intensively at both ends 566a and 566b of the loop hole 565, so that stress generated by the tensile force may be concentrated at both ends 566a and 566b of the loop hole 565. Accordingly, the both ends 566a and 566b of the loop hole 565 correspond to regions that are intensively stretched when a tensile force is applied.

With reference to Table 3, it can be seen that the resin compositions according to embodiments of the disclosure do not exhibit a blooming phenomenon and other appearance damage due to chemical reactions in water, sweat and high humidity environments. The blooming phenomenon is a phenomenon in which additives or internal raw materials in a synthetic resin migrate to the skin layer to whiten the surface or expose foreign substances to the surface. Therefore, the experimental results in Table 3 may be due to the fact that the embodiments of the disclosure used a plasticizer-free polyurethane resin, and the added high specific-gravity inorganic compound did not react with or mediate a reaction with water and polyurethane.

With reference to Table 3, it can be seen that among the resin compositions according to embodiments of the disclosure, Embodiments 5 to 7 have tensile recovery properties equivalent to or superior to those of FKM of the comparative embodiment. When the tensile deformation is large, a paint and a coating material applied to the surface may be damaged during actual production of the resin composition. Comparing Embodiments 1 to 3 with Embodiments 5 to 7, it can be seen that the method for manufacturing a resin composition according to the disclosure includes a first kneading operation S601 and an extrusion operation S602 to perform pretreatment on the resin composition raw material, this improves the uniformity of dispersion of the high specific-gravity inorganic compound within the thermoplastic resin matrix, and mechanical properties are improved due to improved dispersion uniformity. In addition, with reference to Table 3, it can be seen that among the resin compositions according to embodiments of the disclosure, Embodiment 7 in which the mixing ratio of T460A and T465A is 2:1 has the best tensile recovery properties.

Also, with reference to Table 3, it can be seen that among the embodiments of the disclosure, the tensile deformation of the resin compositions according to Embodiments 4, 5, 6 and 7 is less than or equal to that of the resin composition according to the comparative embodiment, and Embodiment 7 has the best tensile recovery properties. When the tensile deformation of a resin composition is large, the paint surface applied to the surface of the resin composition is stretched to cause a paint crack, and due to the difference in tensile deformation between the resin composition and the paint material, the possibility that the paint peels off from the surface of the resin composition to cause appearance defects increases. Therefore, the embodiments of the present disclosure can prevent the above-described cracking and peeling defects of the paint.

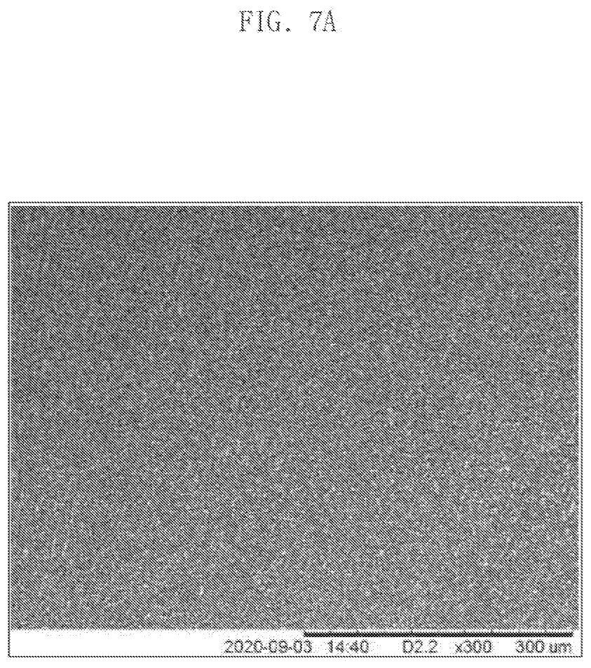

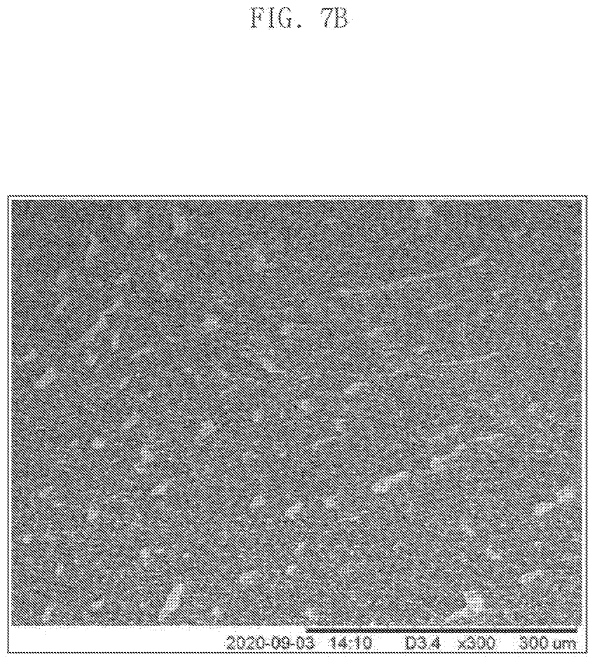

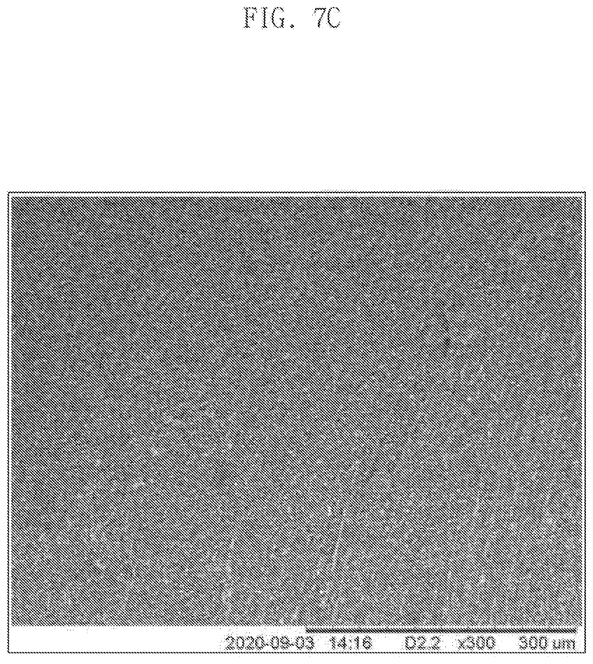

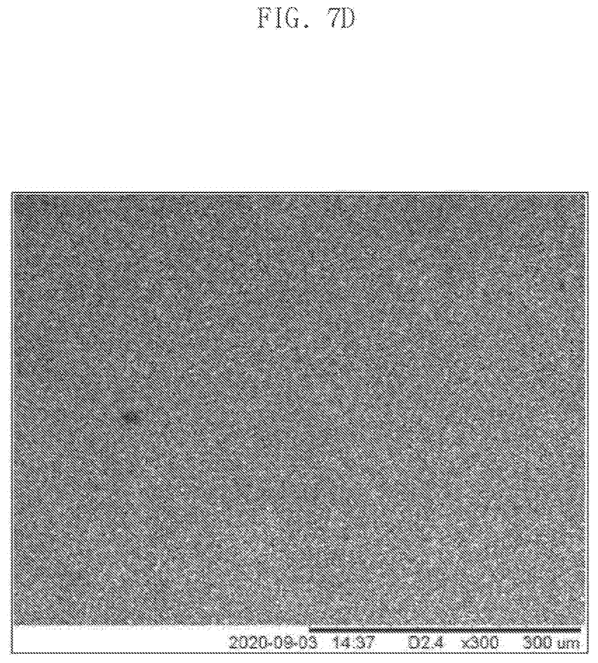

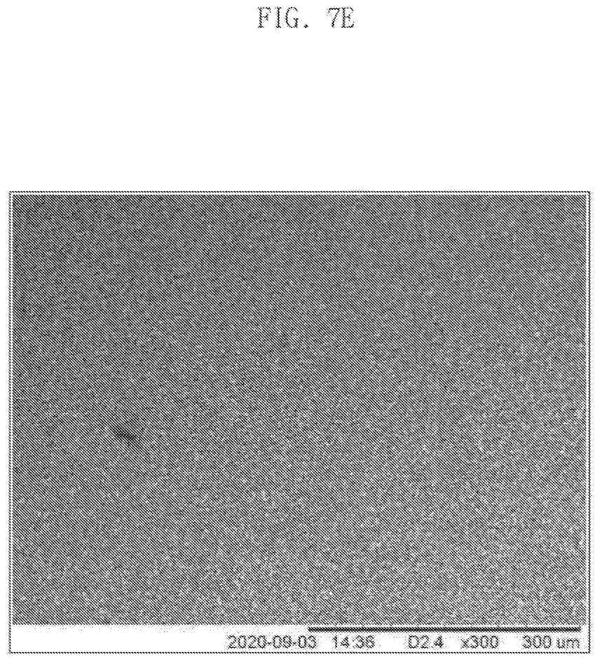

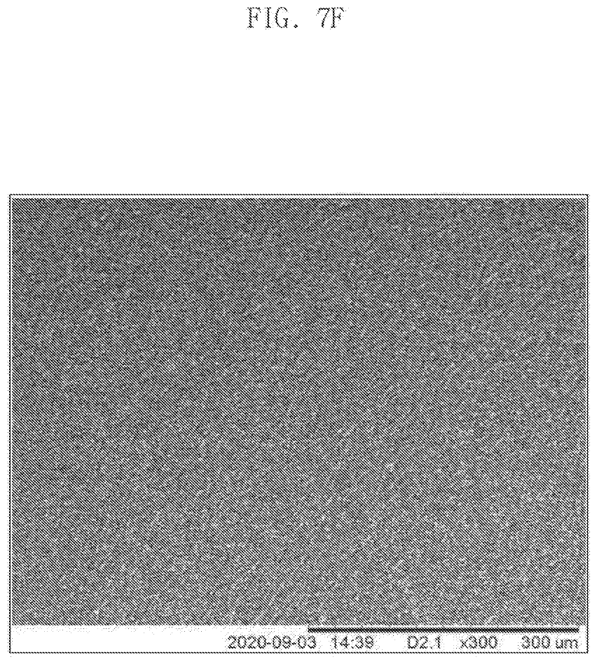

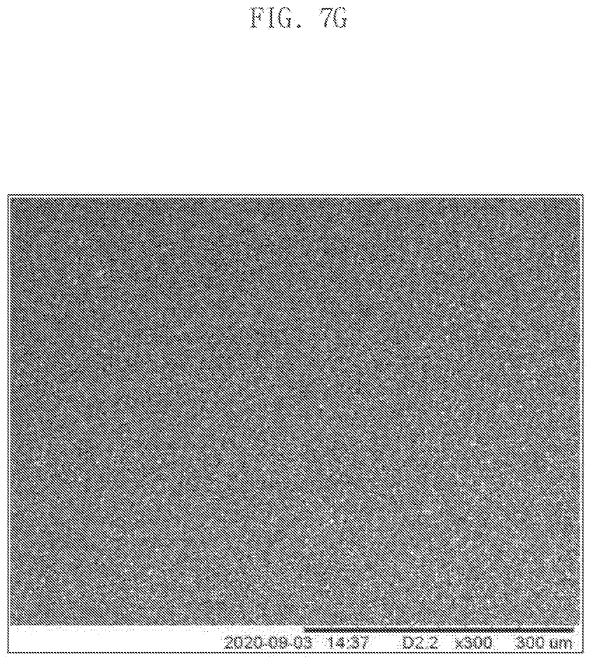

In the following test examples, resin compositions according to embodiments of the disclosure were fabricated, and microstructures of cross sections were observed with an optical microscope. The test results are shown in FIGS. 7A to 7G.

With reference to FIGS. 7A to 7D, it can be seen that the resin compositions according to Embodiments 1 to 4 have relatively low dispersion uniformity of high specific-gravity inorganic compound particles in a matrix made of polyurethane resin. In particular, it can be seen that the aggregation of high specific-gravity inorganic compound particles is remarkable in Embodiments 2 and 3. This may be because Embodiments 1 to 4 were fabricated without a pretreatment process by the first kneading operation S601 and extrusion operation S602 included in the manufacturing method of a resin composition according to the disclosure. Also, in the case of ZnO, it may be because dispersion is relatively not easy in the polyurethane matrix. This decrease in dispersion uniformity may be the cause of the relative decrease in mechanical properties of Embodiments 1 to 4, which can be seen in Tables 2 and 3.

With reference to FIGS. 7E to 7G, it can be seen that the resin compositions according to Embodiments 5 to 7 have relatively good dispersion uniformity of high specific-gravity inorganic compound particles in the matrix made of polyurethane resin. This may be because the manufacturing method of a resin composition according to the disclosure sufficiently disperses high specific-gravity inorganic compound particles in the polyurethane matrix by performing the first kneading operation S601 and the extrusion operation S602. In addition, for the good tensile strength, tear strength and tensile recovery force of the resin compositions according to Embodiments 5 to 7 shown in Tables 2 and 3, it can be seen that the high uniformity of the high specific-gravity inorganic compound in the resin composition served as a contributing factor.

A resin composition for a strap of a wearable electronic device according to embodiments of the disclosure may include 50 to 80 percent by weight of a thermoplastic resin having a hardness of 80 Shore A or less, and 20 to 50 percent by weight of a high specific-gravity inorganic compound, and the resin composition may have a specific gravity of 1.6 or more, a hardness of 50 to 80 Shore A, a tensile strength of 15 to 27 MPa, and a tear strength of 53 to 79 kgF/cm².

In an embodiment, the thermoplastic resin may be a plasticizer-free thermoplastic polyurethane resin. In an embodiment, the plasticizer-free thermoplastic polyurethane resin may include a first thermoplastic polyurethane resin having a relatively low hardness, and a second thermoplastic polyurethane resin having a relatively high hardness.

In an embodiment, the hardness of the first thermoplastic polyurethane resin and the hardness of the second thermoplastic polyurethane resin may be 66 Shore A and 71 Shore A, respectively. In an embodiment, the mixing ratio of the first thermoplastic polyurethane resin and the second thermoplastic polyurethane resin may be 1:2 to 2:1 by weight. In an embodiment, the mixing ratio of the first thermoplastic polyurethane resin and the second thermoplastic polyurethane resin may be 2:1 by weight.

In an embodiment, the high specific-gravity inorganic compound may include at least one of zinc oxide or barium sulfate. In an embodiment, the thermoplastic resin may include a mixture of a first thermoplastic polyurethane resin having a hardness of 66 Shore A and a second thermoplastic polyurethane resin having a hardness of 71 Shore A at a weight ratio of 2:1, the high specific-gravity inorganic compound may include barium sulfate, and the mixing ratio of the thermoplastic resin and the high specific-gravity inorganic compound may be 3:2 by weight.

A method of manufacturing a resin composition for a strap of a wearable electronic device according to another embodiment of the disclosure may include: a first kneading operation of preparing a mixture by kneading 50 to 80 percent by weight of a thermoplastic resin having a hardness of 80 Shore A or less and 20 to 50 percent by weight of a high specific-gravity inorganic compound; an extrusion operation of extrusion-molding the mixture into pellets by extruding the mixture with a first extruder; a second kneading operation of kneading the mixture extrusion-molded into pellets by putting it into a second extruder; and an injection operation of performing molding by injecting the kneaded mixture into a mold from the second extruder.

In an embodiment, the first kneading operation may be performed until the temperature of the mixture being kneaded reaches 180 degrees Celsius. The process temperature of the extrusion operation may be 120 degrees Celsius to 180 degrees Celsius. The process temperature of the second kneading operation may be 180 degrees Celsius to 220 degrees Celsius.

In an embodiment, the second extruder of the second kneading operation may be a twin-screw extruder. The screw rotation speed of the twin-screw extruder may be 180 rpm to 320 rpm.

A wearable electronic device according to another embodiment of the disclosure is a wearable electronic device including a fastening member configured to be detachably fastened to a user's body, wherein the fastening member may include 50 to 80 percent by weight of a thermoplastic resin having a hardness of less than 80 Shore A, and 20 to 50 percent by weight of a high specific gravity inorganic compound, and may have a specific gravity of 1.6 or more, a hardness of 50 to 80 Shore A, a tensile strength of 15 to 27 MPa, and a tear strength of 53 to 79 kgF/cm². In an embodiment, the thermoplastic resin may be a plasticizer-free thermoplastic polyurethane resin. The high specific-gravity inorganic compound may include at least one of barium sulfate or zinc oxide.

In an embodiment, the plasticizer-free thermoplastic polyurethane resin may include a first thermoplastic polyurethane resin having a hardness of 66 Shore A, and a second thermoplastic polyurethane resin having a hardness of 71 Shore A. The mixing ratio of the first thermoplastic polyurethane resin and the second thermoplastic polyurethane resin may be 1:2 to 2:1 by weight. In an embodiment, the thermoplastic resin may include a mixture of the first thermoplastic polyurethane resin and the second thermoplastic polyurethane resin at a weight ratio of 2:1, the high specific-gravity inorganic compound may include barium sulfate, and the mixing ratio of the plasticizer-free thermoplastic resin and the high specific gravity inorganic compound may be a plasticizer-free thermoplastic polyurethane resin having a mixing ratio of 3:2 by weight.

The embodiments of the present disclosure have been shown and described above with reference to the accompanying drawings. The embodiments disclosed in the specification and drawings are only intended to provide specific examples for easily describing the technical content of the disclosure and for assisting understanding of the disclosure, and are not intended to limit the scope of the disclosure. It will be understood by those of ordinary skill in the art that the present disclosure may be easily modified into other detailed forms without changing the technical principle or essential features of the present disclosure, and without departing from the gist of the disclosure as claimed by the appended claims and their equivalents. Therefore, it should be interpreted that the scope of the disclosure includes all changes or modifications derived based on the technical idea of the disclosure in addition to the embodiments disclosed herein.

What is claimed is:

1. A resin composition for a strap of a wearable electronic device, the resin composition comprising:
50 to 80 percent by weight of a thermoplastic resin having a hardness of 80 Shore A or less, and 20 to 50 percent by weight of a high specific-gravity inorganic compound,
wherein the resin composition has a specific gravity of 1.6 or more, a hardness of 50 to 80 Shore A, a tensile strength of 15 to 27 MPa, and a tear strength of 53 to 79 kgF/cm².

2. The resin composition of claim 1, wherein the thermoplastic resin is a plasticizer-free thermoplastic polyurethane resin.

3. The resin composition of claim 2, wherein the non-plasticizer thermoplastic polyurethane resin comprises a first thermoplastic polyurethane resin having a relatively low hardness, and a second thermoplastic polyurethane resin having a relatively high hardness.

4. The resin composition of claim 3, wherein a hardness of the first thermoplastic polyurethane resin and a hardness of the second thermoplastic polyurethane resin are 66 Shore A and 71 Shore A, respectively.

5. The resin composition of claim 3, wherein a mixing ratio of the first thermoplastic polyurethane resin and the second thermoplastic polyurethane resin is 1:2 to 2:1 by weight.

6. The resin composition of claim 5, wherein a mixing ratio of the first thermoplastic polyurethane resin and the second thermoplastic polyurethane resin is 2:1 by weight.

7. The resin composition of claim 1, wherein the high specific-gravity inorganic compound includes at least one of zinc oxide or barium sulfate.

8. The resin composition of claim 7, wherein:
the thermoplastic resin includes a mixture of a first thermoplastic polyurethane resin having a hardness of 66 Shore A, and a second thermoplastic polyurethane resin having a hardness of 71 Shore A at a weight ratio of 2:1;
the high specific-gravity inorganic compound includes barium sulfate; and
a mixing ratio of the thermoplastic resin and the high specific-gravity inorganic compound is 3:2 by weight.

9. A method of manufacturing a resin composition for a strap of a wearable electronic device, the method comprising:
a first kneading operation of preparing a mixture by kneading 50 to 80 percent by weight of a thermoplastic resin having a hardness of 80 Shore A or less and 20 to 50 percent by weight of a high specific-gravity inorganic compound;
an extrusion operation of extrusion-molding the mixture into pellets by extruding the mixture with a first extruder;
a second kneading operation of kneading the mixture extrusion-molded into pellets by putting it into a second extruder; and
an injection operation of performing molding by injecting the kneaded mixture into a mold from the second extruder.

10. The method of claim 9, wherein the first kneading operation is performed until a temperature of the mixture being kneaded reaches 180 degrees Celsius.

11. The method of claim 9, wherein a process temperature of the extrusion operation is 120 degrees Celsius to 180 degrees Celsius.

12. The method of claim 9, wherein a process temperature of the second kneading operation is 180 degrees Celsius to 220 degrees Celsius.

13. The method of claim 9, wherein the second extruder of the second kneading operation is a twin-screw extruder.

14. The method of claim 13, wherein a screw rotation speed of the twin-screw extruder is 180 rpm to 320 rpm.

15. A wearable electronic device including a fastening member configured to be detachably fastened to a user's body, the fastening member comprising a resin composition comprising:
50 to 80 percent by weight of a thermoplastic resin having a hardness of 80 Shore A or less, and 20 to 50 percent by weight of a high specific-gravity inorganic compound,
wherein the resin composition has a specific gravity of 1.6 or more, a hardness of 50 to 80 Shore A, a tensile strength of 15 to 27 MPa, and a tear strength of 53 to 79 kgF/cm².

16. The wearable electronic device of claim 15, wherein the thermoplastic resin is a plasticizer-free thermoplastic polyurethane resin.

17. The wearable electronic device of claim 16, wherein the non-plasticizer thermoplastic polyurethane resin comprises a first thermoplastic polyurethane resin having a relatively low hardness, and a second thermoplastic polyurethane resin having a relatively high hardness.

18. The wearable electronic device of claim 17, wherein a hardness of the first thermoplastic polyurethane resin and a hardness of the second thermoplastic polyurethane resin are 66 Shore A and 71 Shore A, respectively.

19. The wearable electronic device of claim 17, wherein a mixing ratio of the first thermoplastic polyurethane resin and the second thermoplastic polyurethane resin is 1:2 to 2:1 by weight.

20. The wearable electronic device of claim 19, wherein a mixing ratio of the first thermoplastic polyurethane resin and the second thermoplastic polyurethane resin is 2:1 by weight.
